(19) United States
(12) Patent Application Publication
(10) Pub. No.: US 2016/0048001 A1
(43) Pub. Date: Feb. 18, 2016

(54) Mounting System and Method for Night Vision Tubes

(71) Applicant: PHOTONIS USA Pennsylvania, Inc., Lancaster, PA (US)

(72) Inventor: Robert Joseph McCreight, JR., San Antonio, TX (US)

(21) Appl. No.: 14/794,543

(22) Filed: Jul. 8, 2015

Related U.S. Application Data
(60) Provisional application No. 62/021,952, filed on Jul. 8, 2014.
(60) Provisional application No. 62/097,503, filed on Dec. 29, 2014.

(51) Int. Cl. G02B 7/02; F21V 8/00

(52) U.S. Cl. CPC G02B 7/026; G02B 6/0008

(57) ABSTRACT

A mounting system deforms and compresses around a night vision tube within a housing, providing resistance to movement and dampening environmental shock. Also shown is a mounting system for a night vision tube in a night vision system that allows for retrofitting a smaller night vision tube.

### RELATED APPLICATIONS

This application claims the benefit under 35 U.S.C. 119(e) of U.S. Provisional Application No. 62/021,952, filed on Jul. 8, 2014, and U.S. Provisional Application No. 62/097,503, filed on Dec. 29, 2014, both of which are incorporated herein by reference in their entirety.

### BACKGROUND OF THE INVENTION

Night vision systems generally comprise a number of components. A front lens system collects infrared light from the environment and provides the light to a night vision tube. The tube magnifies the number of received photons. In a typical tube, incoming light strikes a photocathode plate causing the emission of electrons through a microchannel plate. The electrons then form an image on a photocathode. An eye piece then conditions the image for the viewer. The tube is usually contained within a housing that is threaded at either end to mate with the front lens system and the eye piece.

In general, night vision systems should be both small and mechanically robust. Often night visions system are handheld, mounted on device (such as a weapon), or mounted on a helm. For each of these scenarios, size and weight should be minimized. At the same time, night vision systems are typically used in the field and are exposed to extreme environments.

### SUMMARY OF THE INVENTION

Current mounting systems for night vision tubes result in night visions systems that are larger than required due to the need to shock dampen the night vision systems by using mass, excess size, and/or additional materials. This is largely due to the fragility and shape of the night vision tube. These conventional mounting systems contain a large proportion of metal parts and are otherwise bulky and utilize an ineffective mechanical design to ease the felt recoil while also maintaining tube position within an augmentation/clone (clip-on) night vision system, for example.

The present system can be used in various night vision designs and incorporates improved housing mounting designs. This system can also be made compatible with current front/rear optics, power supplies, modules, and components.

A mounting system for a night vision tube in a night vision system is also described that allows for retrofitting a smaller night vision tube into a housing designed for a larger tube.

In general according to one aspect, the invention features a night vision system comprising a housing, a night vision tube that magnifies incoming light, and a resilient sleeve between the housing and the night vision tube.

In embodiments, the resilient sleeve is fabricated from plastic, such as PET plastic.

A front compression buffer can also be used between a front of the sleeve and the night vision tube and the housing, and this compression buffer can be integral with the sleeve.

In one embodiment, the sleeve has a port providing access to electrical contacts of the tube. In others, it has a shorten length.

A retaining ring can be used to compress the sleeve against the housing. Here, the retaining ring engages threads in a rear of the housing. Further, a rear buffer can also be used, behind the night vision tube and the sleeve.

In embodiments, a light pipe transmits light from a battery pack to a user's orbital field of view.

The sleeve can include an electronics path for connecting power from a battery pack to electrical contacts on the night vision tube. This electronic path can include electrical conductors extending between the battery pack, through routing cutouts formed in the sleeve to the electrical contacts.

In general according to another aspect, the invention features a night vision system comprising a housing designed to receive a larger diameter night vision tube. A smaller diameter night vision tube that magnifies incoming light is then installed within the housing. A sleeve is used between the housing and the smaller diameter night vision tube to compensate for its smaller diameter.

In general according to still another aspect, the invention features a method of mounting a smaller diameter night vision tube in a night vision system housing designed for a larger diameter night vision tube. This method comprises installing the smaller diameter night vision tube in the housing and compensating for its smaller diameter with a sleeve between the housing and the smaller diameter night vision tube.

The above and other features of the invention including various novel details of construction and combinations of parts, and other advantages, will now be more particularly described with reference to the accompanying drawings and pointed out any claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 illustrates a scale exploded view of a night vision system according to the present invention;

FIG. 2 is a reverse angle scale exploded view of the night vision system;

FIG. 3 is a scale cross-sectional view of the night vision system;

FIG. 4 is a cross-sectional perspective view and FIG. 5 is a bottom perspective view showing a second embodiment of the night vision system including a compression sleeve that enables a 16 millimeter (mm) night vision tube to be retrofitted into a housing designed for an 18 mm tube and allows existing lenses to be retained (if desired);

FIG. 6 is a perspective view showing a side-by-side comparison of a standard 18 mm tube and a 16 mm tube including the compression sleeve;

FIG. 7 is a perspective exploded showing a variant design for the light pipe ring that interlocks with the rear buffer;

FIG. 8 illustrates a scale exploded view of a night vision system according to a third embodiment; and

FIG. 9 is a cross-sectional perspective view showing a fourth embodiment of the night vision system.

### DETAILED DESCRIPTION OF THE PREFERRED EMBODIMENTS

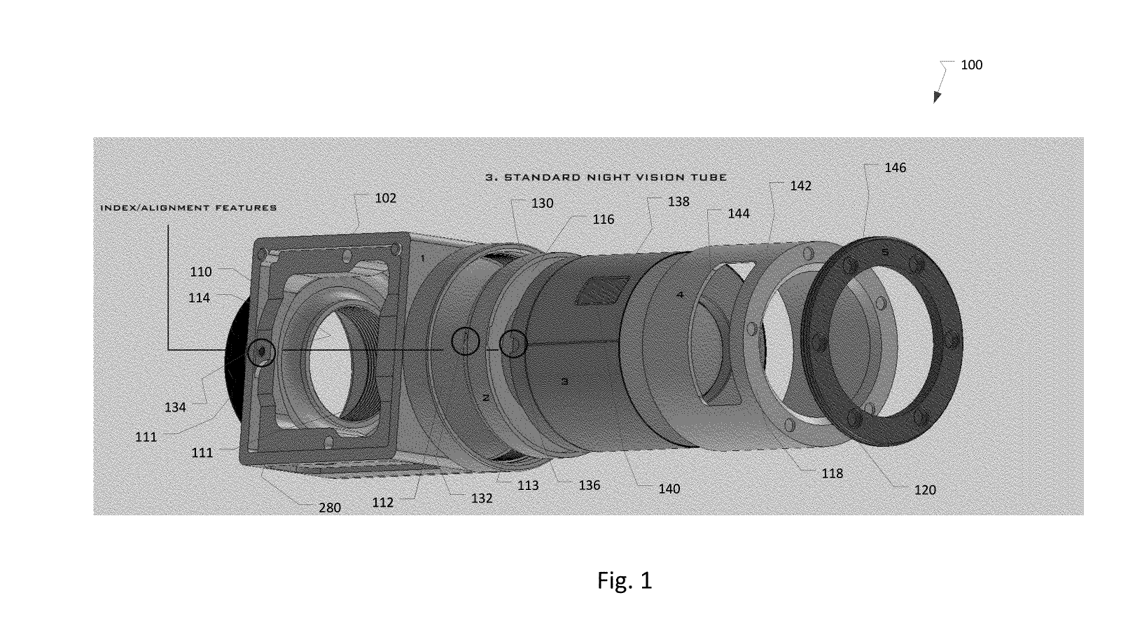

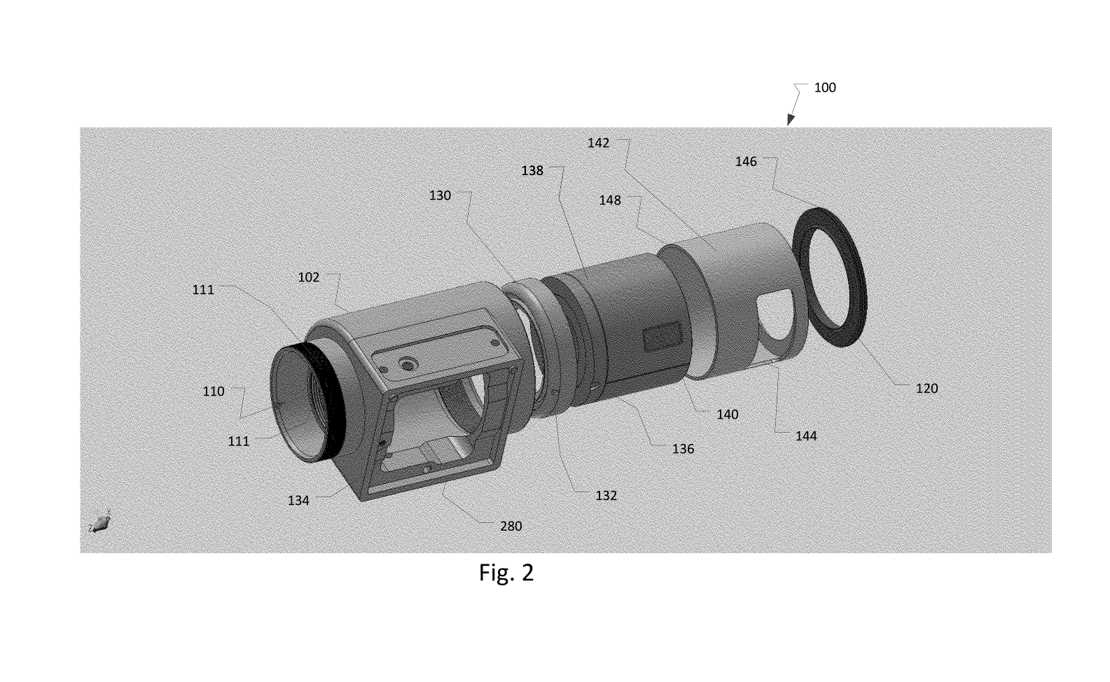

FIGS. 1-3 show a night vision system 100 constructed according to the principles of the present invention.

A generally cubic-shaped hyper body functions as an outer housing 102 for the night vision system 100. It has a wall section 280 to which a battery pack mounts. Along its central axis, the housing 102 has an entrance aperture 110 through which light enters the system 100. Typically this light is collected by collection optics such as a front lens system, which is attached to the entrance aperture 110 via front threads 111 formed in the housing 102.

Light is transmitted to the user's eye through an exit aperture 112, to which eyepiece optics are typically attached. The eyepiece or rear lens system mates to the housing 102 via rear threads 113 formed in the housing 102.

Inserted through the exit aperture are a series of components that are used to mount the night vision tube 138 in the housing 102.

An annular shaped front compression buffer 130 seats against a concave thrust surface 114 of the housing 102. The front compression buffer 130 includes a keying feature 132, which is a recess in the outer wall of the front buffer 130, that interfaces with an indexing pin 134, which pin is inserted through a side wall of the housing 102. The indexing pin 134 and buffer keying feature 132 together assure that the compression buffer 130 has the proper rotational alignment with respect to the housing 102. This front buffer 130 is deformable and is preferably constructed from polyethylene terephthalate (PET) plastic.

Next, the largely cylindrical night vision tube 138 is inserted through the exit aperture 112 and seats against the front compression buffer 130. The night vision tube 138 similarly includes a tube keying feature 136, such as a recess in the outer wall of the tube 138 that interfaces with the indexing pin 134 and/or a male feature of the front compression buffer 130, to ensure that the tube has a proper rotation alignment relative to the housing 102. Two electrical contacts or power tabs 140 are located on the outer wall of the tube 138.

A hollow cylindrical compression sleeve 142 is then inserted over the night vision tube and seats against the thrust surface 116 of the front compression buffer. An electrical contact port 144 is formed through an outer wall of the skirt of the compression sleeve 142 to enable electrical access to the electrical contacts 140 of the tube 138.

A retaining ring 146 has a threaded outer peripheral surface 120 that mates with the internal rear threads 113 formed in the housing 102 in the exit aperture 112. The retaining ring 146 is used to compress the compression sleeve 142 over the night vision tube 138 and against the compression buffer 130.

The combination of the compression buffer 130 and the compression sleeve 142 functions to sheath, isolate, and compress the night vision tube 138 in a moldable/deformable sheath.

In some embodiments, this sleeve system 142 varies in skirt length and/or an additional rear deformable buffer(s) is/are included. Such a rear buffer is preferably annularly shaped like the front compression buffer 130. Such rear buffer is preferably installed between the rear thrust surface 118 of the compression sleeve 142 or rear shoulder over the tube 138 and the retaining ring 142.

The compression sleeve 142 is a single or multiple piece design. An important feature, however is that the night vision tube 138 is sheathed from the front, sides and rear by the compression sleeve 142 that is under compression by retaining ring 146 engaging and thrusting against the rear thrust surface 118 and thus thrusting the forward end 148 of the sleeve 142 against the compression buffer 130.

In various designs, intermediate sleeve(s) may be included to support the night vision tube 138 between the front and rear compression elements, see front compression buffer 130 and rear thrust surface 118, and to allow the inclusion of 16 mm night vision tube. The 16 mm tube requires an electric trace from the mid-rear of the standard 18 mm tube area to the front-mid area of the 16 mm tube surface area.

The compression sleeve 142 is preferably fabricated from PET plastic. This plastic is resilient, exhibits only slight deformity while dampening shock, is not prone to cracking and is not fragile. It provides the right amount of deformation under compression to allow some molding fit while not over deforming and collapsing under recoil.

The sizing of the resilient compression sleeve 142 is important, specifically between the maximum outside diameter (OD) of the night vision tube 138 and the internal diameter (ID) of the compression sleeve 142. This should be a snug fit as the very slight irregularities of the tube circumference allow hand pressure to insert the tube 138 into the sleeve 142.

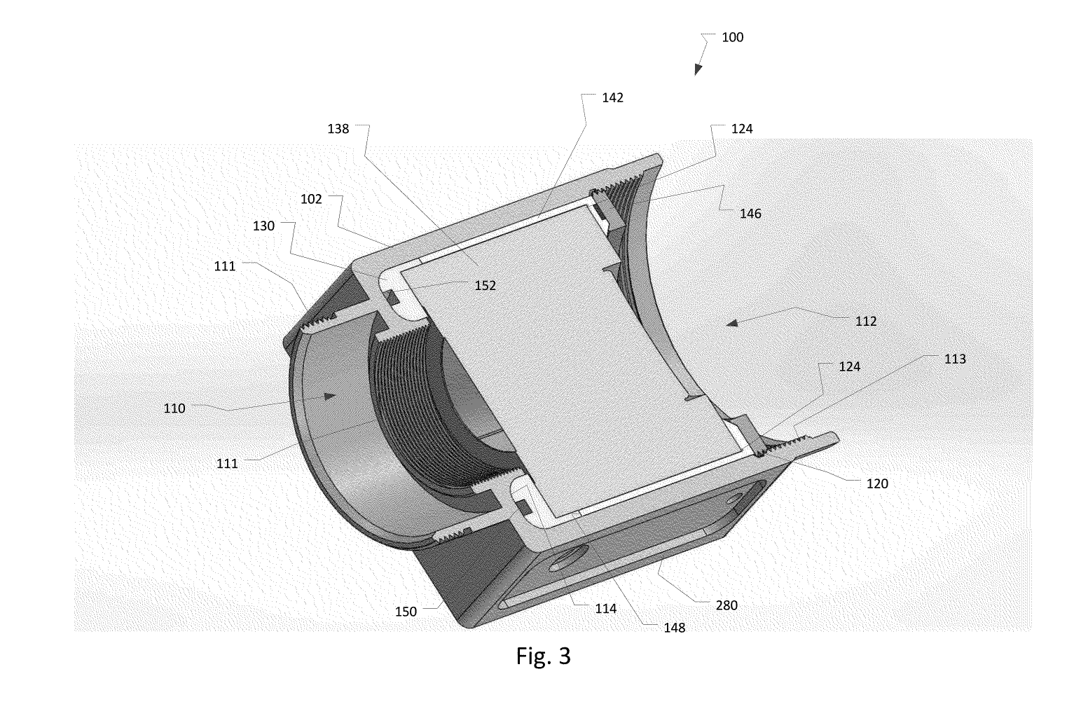

In some embodiments, a very slight angled ring projection 124 (see FIG. 3) is provided that extends around the circumference of the internal corner of the plastic compression sleeve 142. This functions as a forcing cone to the OD of the tube 138. This then adds a bit more compression when the retaining ring 146 (preferably brass) is tightened down.

The housing is metal, in this case aluminum. In other embodiments, the housing 102 is manufactured from titanium and other noble materials i.e., a material that resists chemical action, does not corrode, and is not easily attacked by acids. The inside of the housing 102 where the sleeve stops (114) is concave radius of about 0.09″, so it is semi-circular in cross-section. The compression sleeve 142 also has a radius with the same curvature, but male or convex profile.

Under compression, the exoskeleton of the tube 138 crushes the PET compression sleeve 142 forward until it stops at the radius of the housing 102. A few things occur here. The PET front compression buffer 130 deforms very slightly into the front of the housing 102. The PET form fits to the micro abrasions of the tooling marks in the housing, it bulges slightly outward against the inside of the metal housing creating a compression/friction fit (anti-rotation), it deforms slightly inward (by design) to match the diameter of the light path and optics raceway.

The brass retaining ring 124 and compression sleeve rear portion has a rear centering feature. As the rear retaining ring 124 is tightened, the compressing motion also centers the rear of the tube with a beveled edge that also deforms slightly. The front and rear PET components deform at the same time as the rear brass retaining ring 124 is tighten. This self-aligns and centers the tube 138 in the housing 102.

Total compression is roughly 0.005″ from the rear end of the brass retaining ring to the front of the PET front compression buffer 130.

In some examples, O-ring seals 150 are included in the front end, in a recess 152 formed in the leading edge of the compression buffer 130. This allows the front lens system, which is attached to the entrance aperture 110 via front threads 111, to be removed without losing the barometric integrity of the tube and electronics inside. Typically, the system is purged through a screw hole post assembly. Further, users can then add larger optics on this modularly without a complete disassembly.

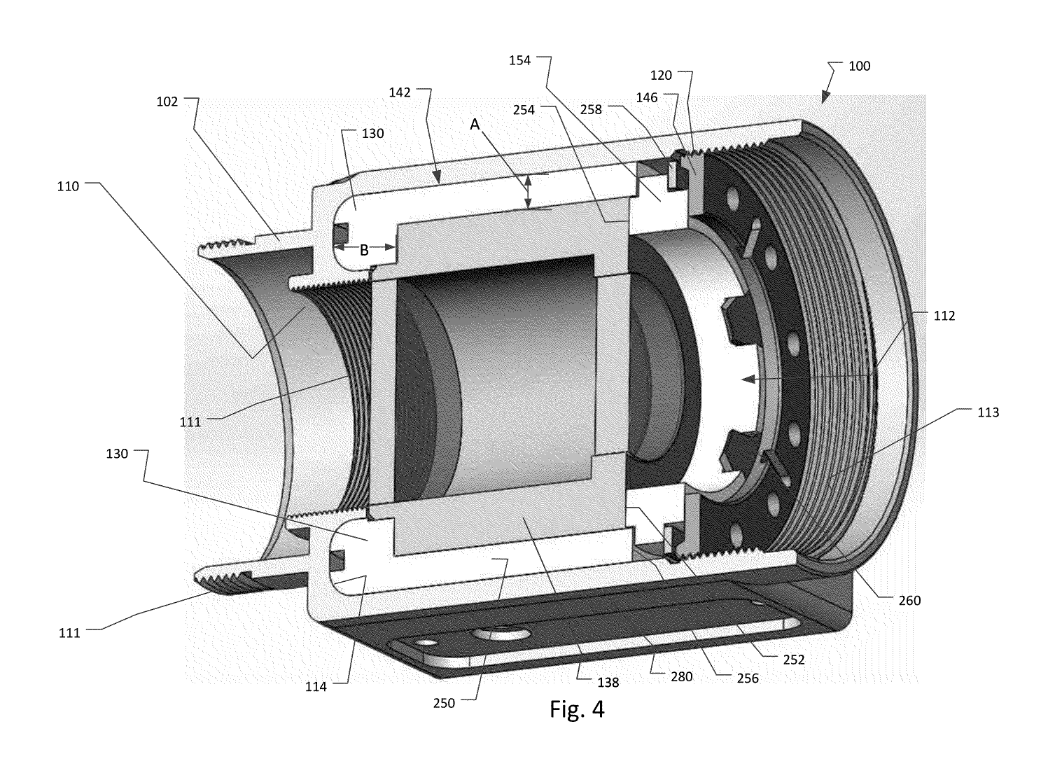

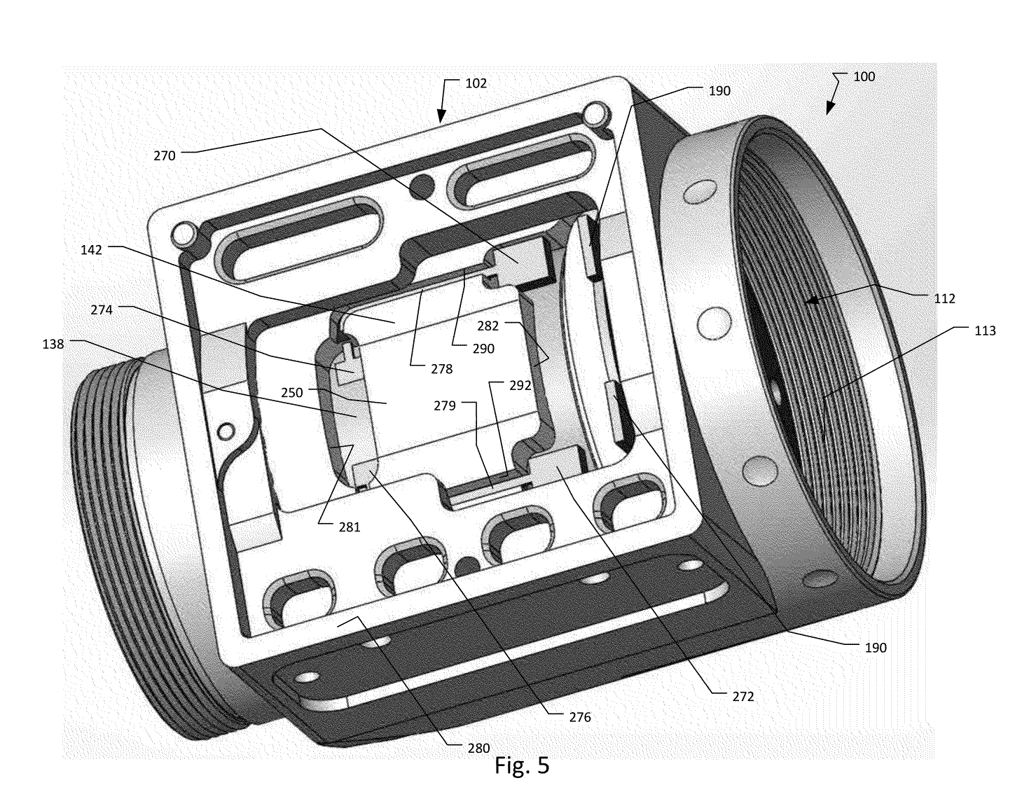

FIGS. 4 and 5 show a second embodiment of the night vision system 100 including a compression sleeve 142 that enables a 16 millimeter (mm) night vision tube to be retrofitted into a housing 102 designed for an 18 mm tube and allowing existing lenses to be retained (if desired).

An advantage of this retrofit is that the 16 mm tube, while a non-standard tube, has a decreased mass relative to the 18 mm tube. Yet, new jumps in resolution allow the 16 mm tube to achieve similar resolution and meet other performance criteria. This retrofit is relevant both to legacy devices currently-fielded, and newer chassis in which the 18 mm is typical.

In more detail, referring to FIG. 4, the compression sleeve 142 has thicker (A) outer skirt wall 250 in the radial direction than the embodiment of FIG. 1. This added thickness takes-up the extra room created by using the smaller 16 mm tube. Further, the front compression buffer 130 has a higher profile B in the longitudinal direction and is integrated with the compression sleeve 142 in this example to form a unitary piece.

Added is an annular or washer-shaped rear buffer 154 between the compression sleeve 142 and the rear shoulder 252 of the night vision tube and the retaining ring 146. The function of the rear buffer 154 is also to take up the extra space created when installing the smaller 16 mm tube. In the illustrated embodiment, the front face 254 of the rear buffer 154 engages both the rear shoulder 252 of the tube 138 and the rear surface 256 of the compression sleeve 142. The deformability of the compression sleeve 142 and rear buffer 154 ensures a tight/firm fit for the tube 138.

In the illustrated embodiment, a light pipe ring 258 is also provided. In the illustrated embodiment, transparent plastic is used that is in the shape of a ring around the tube. When the low battery LED blinks or the IR LED is “ON” those LED emissions travel from the battery pack, which mounts to the wall section 280 of the housing 102, into the light pipe entrance aperture tabs 190 through the light pipe ring 258 and to the tabs 260 that extend into the field of view (FOV) as it is displayed orbital around the eyepiece.

Currently, the contact points on the 18 mm tube are highly standardized among manufacturers. Due to its decreased size, the 16 mm contact points are not indexed to fit the standard battery housing contact points on the 18 mm tube. To enable to standard contact points to power the 16 mm tube, a set of leads travels from the typical contact point-through the sleeve-and to the 16 mm contact points.

FIG. 5 shows the leads in the 16 mm/18 mm sleeve 142 that enable access to the 16 mm contact points on the tube 138.

Included in the compression sleeve 142 is an electronics path in which battery connector/power tabs 270, 272 are provided and located to receive power from the battery housing intended for the 18 mm tube. The battery housing is removed in the figure but normally seals against the square rim wall 280.

Two electrical leads or power traces 278, 279 run from the respective battery connector/power tabs 270, 272 to provide conductivity with and contact to the 16 mm tube contact point tabs 274, 276. These tube contact tabs 274, 276 electrically contact the two electrical contacts or power tabs 140 on the outside of the 16 mm tube so it may be energized.

In the illustrated embodiment, the tube contact point tabs 274, 276 are located in an oblong cutout 281 in the outer wall 250 of the compression sleeve. The battery connector/power tabs 270, 272 are located in a second cutout 282. Finally routing cutouts 290, 292 house the electrical leads 278, 279.

The use of this sleeve 138 and rear buffer as a non-permanent and removable feature enables a user or manufacturer to switch back and forth between 16/18 mm tubes as required. The standard battery compartment/pack would not need to change nor would the main housing/chassis. Also, the front optics need not change either. Only the rear lens may need to be upgraded to travel a bit closer to the tube for focus.

Due to the new 16 mm tube availability and performance updates, along with the significant weight savings this is a valuable option as a device manufacturer-particularly for helmet/head borne weight-providing possibly 70 gram reduction in a dual tube system.

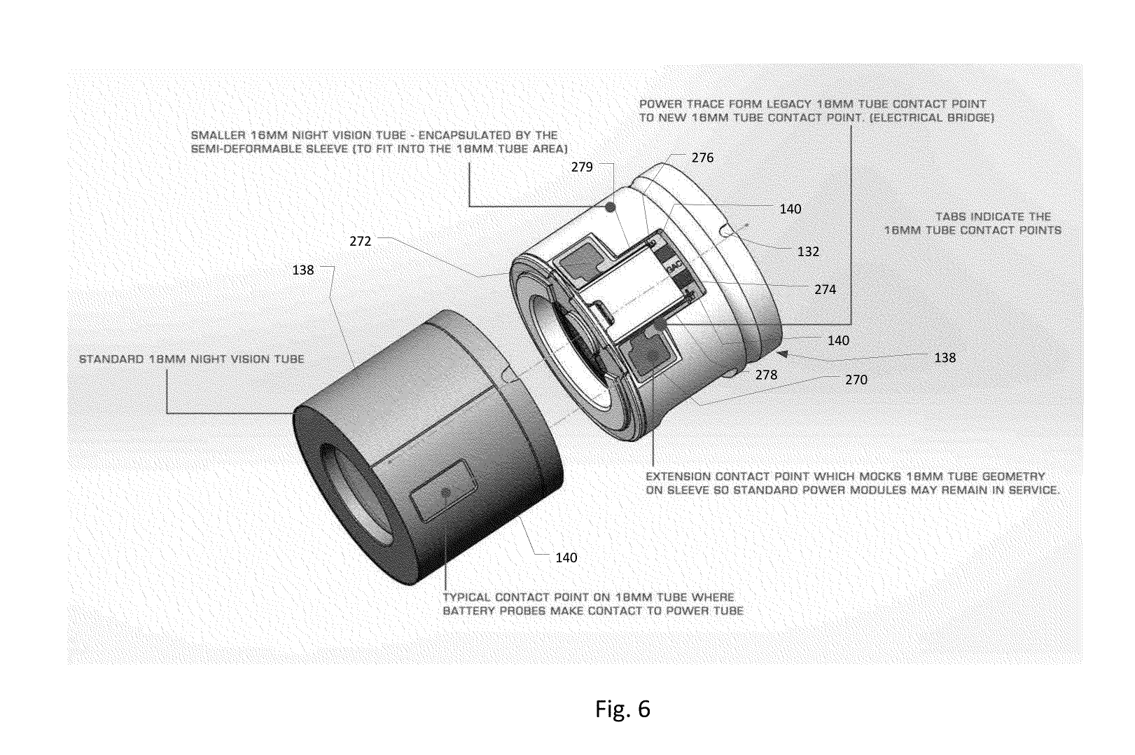

FIG. 6 is a side-by-side comparison of a standard 18 mm tube 138 and a 16 mm tube including the 16 mm/18 mm compression sleeve.

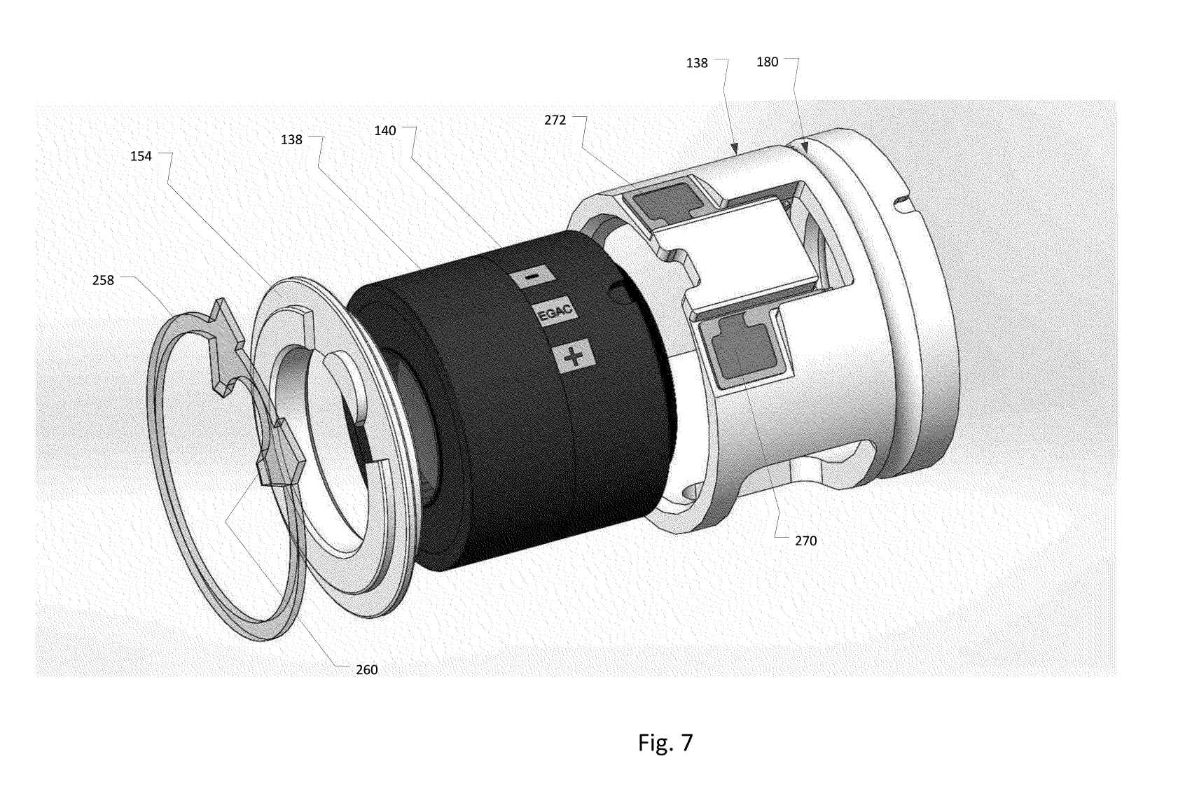

FIG. 7 shows a variant design for a light pipe ring 258 that interlocks with the rear buffer 254.

This embodiment of the sleeve 138 also includes an annular thinned section 180. The resulting region of reduced thickness of the sleeve 138 increases the resulting deformation of the length of the sleeve 138 for the same level of longitudinal stress.

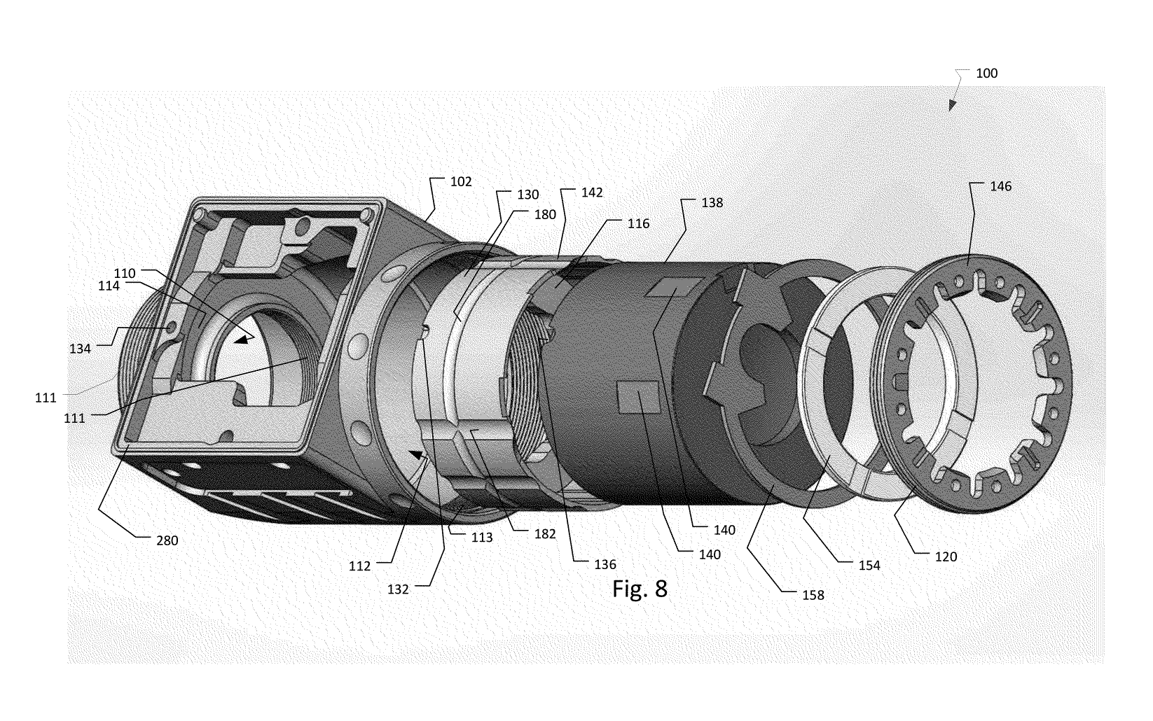

FIG. 8 shows a night vision system 100 according to third embodiment.

Similar to the embodiment of FIG. 1-3, a generally cubic-shaped outer housing 102 for the night vision system 100 has a wall section 280 to which a battery pack mounts.

In this embodiment, the front compression buffer 130 is integral with the hollow cylindrical compression sleeve 142. Further, the longitudinal length of the skirt of sleeve 130 is shortened to expose the electrical contacts 140 of the tube 138, avoiding the need for an electrical contact port.

Here, a rear buffer 154 is used, with the light pipe ring 258 being sandwiched between the rear of the night vision tube 138 and the rear buffer 154. The retaining ring 146 mates with the internal rear threads 113 formed in the housing 102 in the exit aperture 112. The retaining ring 146 compresses the rear buffer 154 against the night vision tube 138 and the tube against the front compression buffer 130.

The illustrated compression sleeve 142 includes the annular thinned section 180 to control longitudinal compression. It further includes axially-directed thinned sections 182 to control the circumferential interference fit around the tube 138 and within the housing 102.

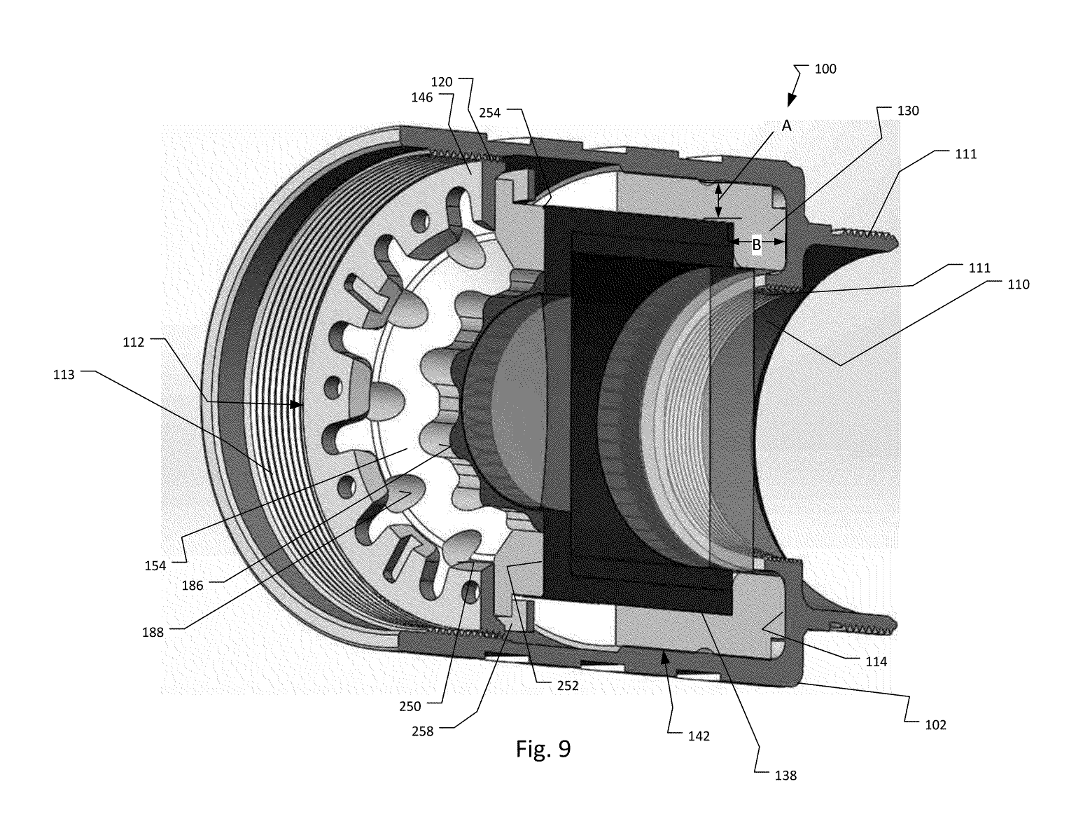

FIG. 9 shows a fourth embodiment of the night vision system 100 including a compression sleeve 142 and rear buffer 154 that enable a 16 millimeter (mm) night vision tube to be retrofitted into a housing 102 designed for an 18 mm tube.

In this example, the rear buffer 154 has a scalloped inner edge profile 186. This profile ensures an even distribution of stress over the rear shoulder 252 of the tube 138.

For stress distribution and to control the compressibility of the rear buffer 154, axially-directed holes 188 are included through the length of the rear buffer 154, arranged around the center port of the buffer 154.

While this invention has been particularly shown and described with references to preferred embodiments thereof, it will be understood by those skilled in the art that various changes in form and details may be made therein without departing from the scope of the invention encompassed by the appended claims.

What is claimed is:

1. A night vision system, comprising:
a housing;
a night vision tube that magnifies incoming light; and
a resilient sleeve between the housing and the night vision tube.

2. The system of claim 1, wherein the resilient sleeve is fabricated from plastic.

3. The system of claim 1, wherein the resilient sleeve is fabricated from PET plastic.

4. The system of claim 1, further comprising a compression buffer between a front of the sleeve and the night vision tube and the housing.

5. The system of claim 4, wherein the compression buffer is integral with the sleeve.

6. The system of claim 1, wherein the sleeve has a port for providing access to electrical contacts of the tube.

7. The system of claim 1, further comprising a retaining ring that compresses the sleeve against the housing.

8. The system of claim 7, wherein the retaining ring engages threads in a rear of the housing.

9. The system of claim 1, further comprising a rear buffer behind the night vision tube and the sleeve.

10. The system of claim 9, wherein a retaining ring compresses the rear buffer against a rear shoulder of the night vision tube and a rear surface of the sleeve.

11. The system of claim 1, further comprising a light pipe for transmitting light from a battery pack to a user's orbital field of view.

12. The system of claim 1, wherein the sleeve includes an electronics path for connecting power from a battery pack to electrical contacts on the night vision tube.

13. The system of claim 12, wherein the electronic path includes electrical conductors extending between the battery pack, through routing cutouts formed in the sleeve to the electrical contacts.

14. A night vision system, comprising:
a housing designed to receive a larger diameter night vision tube;
a smaller diameter night vision tube that magnifies incoming light installed within the housing; and
a sleeve between the housing and the smaller diameter night vision tube that compensates for its smaller diameter.

15. The system of claim 14, wherein the sleeve is fabricated from plastic.

16. The system of claim 14, further comprising a compression buffer between a front of the sleeve and the night vision tube and the housing.

17. The system of claim 14, further comprising a retaining ring that compresses the sleeve against the housing.

18. The system of claim 14, further comprising a rear buffer behind the night vision tube and the sleeve.

19. The system of claim 14, wherein the sleeve includes an electronics path for connecting power from a battery pack to electrical contacts on the night vision tube.

20. The system of claim 19, wherein the electronic path includes electrical conductors extending between the battery pack, through routing cutouts formed in the sleeve to the electrical contacts.

21. A method of mounting a smaller diameter night vision tube in a night vision system housing designed for a larger diameter night vision tube, the method comprising:
installing the smaller diameter night vision tube in the housing; and
compensating for its smaller diameter with a sleeve between the housing and the smaller diameter night vision tube.
